(19) United States
(12) Patent Application Publication
(10) Pub. No.: US 2015/0303473 A1
(43) Pub. Date: Oct. 22, 2015

(54) CO-SOLVENT ASSISTED MICROWAVE-SOLVOTHERMAL PROCESS FOR MAKING OLIVINE LITHIUM TRANSITION METAL PHOSPHATE ELECTRODE MATERIALS

(71) Applicants: Murali G. Theivanayagam, Midland, MI (US); Ing-Feng Hu, Midland, MI (US); Yu-Hua Kao, Midland, MI (US); Lingbo Zhu, Midland, MI (US); Stacie L. Santhany, Auburn, MI (US); Ying Shi, Painted Post, NY (US); Jui-Ching Lin, Midland, MI (US); Towhid Hasan, Midland, MI (US); Robin P. Ziebarth, Midland, MI (US); Xindi Yu, Midland, MI (US); Michael M. Oken, Midland, MI (US)

(72) Inventors: Murali G. Theivanayagam, Midland, MI (US); Ing-Feng Hu, Midland, MI (US); Yu-Hua Kao, Midland, MI (US); Lingbo Zhu, Midland, MI (US); Stacie L. Santhany, Auburn, MI (US); Ying Shi, Painted Post, NY (US); Jui-Ching Lin, Midland, MI (US); Towhid Hasan, Midland, MI (US); Robin P. Ziebarth, Midland, MI (US); Xindi Yu, Midland, MI (US); Michael M. Oken, Midland, MI (US)

(21) Appl. No.: 14/646,682

(22) PCT Filed: Mar. 4, 2013
(86) PCT No.: PCT/US2013/028835

§ 371 Date: May 21, 2015

Related U.S. Application Data
(60) Provisional application No. 61/740,586, filed on Dec. 21, 2012.

(51) Int. Cl. H01M 4/58; H01M 10/0525; C01B 25/45

(52) U.S. Cl. CPC H01M 4/5825; C01B 25/45; H01M 10/0525; C01P 2006/40; H01M 2220/20; H01M 2220/30

(57) ABSTRACT

Olivine lithium transition metal phosphate cathode materials are made in a microwave-assisted process by combining precursors in a mixture of water and an alcoholic cosolvent, then exposing the precursors to microwave radiation 5 to heat them under superatmospheric pressure. This process allows rapid synthesis of the cathode materials, and produces cathode materials that have high specific capacities.

The present invention relates to a method for making olivine lithium transition metal electrode materials.

Lithium batteries are widely used as primary and secondary batteries for vehicles and many types of electronic equipment. These batteries often have high energy and power densities.

Olivine lithium transition metal compounds are becoming of interest as cathode materials in these batteries. For example, LiFePO₄ is known as a low cost material that is thermally stable and has low toxicity and high rate capability (high power density). However, LiFePO₄ has a relatively low working voltage (3.4V vs. Li+/Li) and because of this has a low energy density. Therefore, olivine materials having mixtures of iron and another transition metal such as manganese are being investigated. Manganese has a higher working voltage than iron, and for that reason potentially offers a route to increasing working voltage and energy density.

Olivine lithium transition metal phosphates having good electrochemical properties are difficult to synthesize. Olivine lithium manganese iron phosphates (LMFP) in particular are difficult to synthesize. Several approaches have been described, but all have difficulties. One method is a dry milling process, in which precursor materials are milled together to form a fine particulate, which is further calcined to produce the olivine material. This process is time and energy intensive, and is not easily scalable to commercial production. Wet methods exist, but often require long reaction times and/or energy-intensive calcining steps. In addition, wet methods generally require a large excess of lithium precursor. The lithium precursor is the most expensive raw material, and the need to use a large excess of the lithium precursor greatly increases expense. An economical commercial process would require that the excess lithium be recovered and re-used, which again increases production costs.

The problem is made more difficult because the electrochemical properties of the materials are very sensitive to production conditions, especially for LMFP materials. LMFP materials often exhibit specific capacities far below theoretical values and also tend to lose capacity rapidly as they undergo charge/discharge cycles. Any commercial process for making these materials must, in addition to being scalable and economical, produce a material having high specific capacity and acceptable capacity retention during cycling.

US Published Patent Application No. 2009/0117020 describes a microwave-assisted solvothermal process for making phospho-olivine cathode materials. In that process, the olivine materials are precipitated from tetraethylene glycol solution or from aqueous solution. This process has the advantage of rapidly forming an olivine lithium transition metal phosphate. Whereas this method produced a LiFePO₄ electrode material that had good electrochemical properties, when this method was used to produce LiMnPO₄, the material had a specific capacity of only about 40 mAh/g, which is very poor. When this process is performed using only a stoichiometric amount of lithium (about 1 mole per mole of phosphate ions), the product tends to contain far less lithium than expected. This has an adverse effect on electrochemical performance.

This invention is a microwave-assisted, solvothermal method for making olivine lithium transition metal phosphate particles, comprising the steps of:

a) combining precursor materials including at least one source of lithium ions, at least one source of transition metal ions, and at least one source of HₓPO₄ ions where x is 0-2, in a solvent mixture of 20 to 80% by weight water and 80 to 20% by weight of at least one liquid alcoholic cosolvent which is miscible with water at the relative proportions of water and cosolvent that are present, to form a mixture,

b) exposing the mixture formed in step a) to microwave radiation in a closed container to heat the mixture to a temperature of at least 150° C., form superatmospheric pressure in the closed container and convert the precursor materials to an olivine lithium transition metal phosphate and

c) separating the olivine lithium transition metal particles from the solvent mixture.

The process of the invention is a fast and simple method which produces olivine lithium transition metal phosphate particles that exhibit unexpectedly high specific capacities. A particular advantage is that this process can produce lithium manganese iron phosphate (LMFP) electrode materials having high specific capacity. This is an important advantage of the invention, because LMFP materials have a high theoretical capacity and therefore are of interest in producing high energy density batteries.

Another advantage of this invention is that lithium is efficiently incorporated into the olivine lithium transition metal material, even when only an approximately stoichiometric amount of lithium precursor is provided to the reaction mixture. Therefore, in certain preferred embodiments, only an approximately stoichiometric amount of lithium is needed, and the raw material cost associated with the use of an excess of that expensive reagent is avoided or minimized, as is the need to recover unused lithium compounds.

In step a) of the process of this invention, precursor materials including at least one source of lithium ions, at least one source of transition metal ions, and at least one source of HₓPO₄ ions where x is 0-2, are combined. The precursor materials are compounds other than a lithium transition metal olivine, which react to form a lithium transition metal olivine. Some or all of the precursor materials may be sources for two or more of the necessary starting materials.

The source of lithium ions may be, for example, lithium hydroxide or lithium dihydrogen phosphate. Lithium dihydrogen phosphate functions as a source for both lithium ions and HₓPO₄ ions, and can be formed by partially neutralizing phosphoric acid with lithium hydroxide prior to being combined with the rest of the precursor materials.

The transition metal ions preferably include at least one of iron (II), cobalt (II), and manganese (II) ions, and more preferably include iron (II) ions and manganese (II) ions. Suitable sources of these transition metal ions include iron (II) sulfate, iron (II) nitrate, iron (II) phosphate, iron (II) hydrogen phosphate, iron (II) dihydrogen phosphate, iron (II) carbonate, iron (II) hydrogen carbonate, iron (II) formate, iron (II) acetate, cobalt (II) sulfate, cobalt (II) nitrate, cobalt (II) phosphate, cobalt (II) hydrogen phosphate, cobalt (II) dihydrogen phosphate, cobalt (II) carbonate, cobalt (II) formate, cobalt (II) acetate, manganese (II) sulfate, manganese (II) nitrate, manganese (II) phosphate, manganese (II) hydrogen phosphate, manganese (II) dihydrogen phosphate, manganese (II) carbonate, manganese (II) hydrogen carbonate, manganese (II) formate and manganese (II) acetate. The phosphates, hydrogen phosphates and dihydrogen phosphates in the foregoing list will in addition to serving as a source of the transition metal ion also will serve as some or all of the source of HₓPO₄ ions.

In preferred embodiments, the transition metal ions include two or more different transition metals, and a lithium mixed transition metal olivine is produced in the process. In such cases, one of the transition metal ions preferably is Fe(II) and the other transition metal ion is Mn(II) ion. The mole ratio of Fe to Mn ions may be 10:90 to 90:10, and is preferably 10:90 to 50:50. An especially preferred molar ratio of Fe and/or Mn ions is 10:90 to 35:65.

The source of HₓPO₄ ions may be lithium hydrogen phosphate, lithium dihydrogen phosphate, any of the transition metal phosphates, transition metal hydrogen phosphates and transition metal dihydrogen phosphates described before, as well as phosphoric acid.

A dopant metal precursor may also be present, and if present, preferably is present in an amount of 1 to 3 mole-% based on the total moles of transition metal precursors and dopant metal precursors. In some embodiments, no dopant metal is present. The dopant metal, if present, is selected from one or more of magnesium, calcium, strontium, cobalt, titanium, zirconium, molybdenum, vanadium, niobium, nickel, scandium, chromium, copper, zinc, beryllium, lanthanum and aluminum. The dopant metal is preferably magnesium or a mixture of magnesium and with or more of calcium, strontium, cobalt, titanium, zirconium, molybdenum, vanadium, niobium, nickel, scandium, chromium, copper, zinc, beryllium, lanthanum and aluminum. The dopant metal is most preferably magnesium or cobalt or a mixture thereof. The dopant metal precursor is a water-soluble salt of the dopant metal including, for example, a phosphate, hydrogen phosphate, dihydrogen phosphate, carbonate, formate, acetate, glycolate, lactate, tartrate, oxalate, oxide, hydroxide, fluoride, chloride, nitrate, sulfate, bromide and like salts of the dopant metal.

The source of HₓPO₄ ions may be lithium hydrogen phosphate, lithium dihydrogen phosphate, any of the transition metal phosphates, transition metal hydrogen phosphates and transition metal dihydrogen phosphates described before, as well as phosphoric acid.

The mole ratio of lithium ions to HₓPO₄ ions preferably is 0.9:1 to 3.5:1. In some embodiments, an approximately stoichiometric amount of lithium ions is provided based on the amount of HₓPO₄ ions; in such a case the ratio of lithium ions to HₓPO₄ ions may be, for example, from 0.9 to 1.25 moles per mole of HₓPO₄ ions. In other embodiments, a significantly greater than stoichiometric amount of lithium ions are provided, such as from 1.25 to 3.5, especially 2.5 to 3.25 moles of lithium ions per mole of HₓPO₄ ions.

When less than three moles of lithium ions are provided per mole of HₓPO₄ ions, it is generally preferred to add another strong base to the reaction mixture to fully neutralize the phosphate ion source. Typically, enough of such a base is provided to provide the reaction mixture with a pH (at 25° C.) of at least 8.5, preferably 9 to 12. Ammonium hydroxide and ammonia are preferred bases, as are quaternary ammonium compounds (including hydroxides thereof). It is also possible to partially neutralize phosphoric acid with such a base prior to combining it with the other reactants to form the olivine lithium transition metal phosphate.

The mole ratio of transition metal ions (plus any dopant ions, if any) to HₓPO₄ ions suitably is from 0.75:1 to 1.25:1, preferably from 0.85:1 to 1.25:1, more preferably from 0.9:1 to 1.1:1.

In step a), the various precursor materials as described above are dissolved into a mixture of water and a liquid (at 25° C.) alcoholic cosolvent. The cosolvent is miscible with water at the relative proportions of water and cosolvent that are present. By miscible, it is meant simply that the water and cosolvent form a single phase upon mixing. The cosolvent preferably contains one or more hydroxyl groups, preferably one or two hydroxyl groups. The boiling temperature of the cosolvent (at 1 atmosphere pressure) suitably is 30 to 210° C. In some embodiments, the boiling temperature of the cosolvent is 30 to 100° C. In other embodiments, the boiling temperature of the cosolvent is 101 to 210° C., preferably 101 to 180° C.

Examples of suitable cosolvents include alkanols such as methanol, ethanol, isopropanol, n-propanol, n-butanol, t-butanol, sec-butanol, n-pentanol, n-hexanol and the like; alkylene glycols and glycol ethers such as ethylene glycol, diethylene glycol, triethylene glycol, tetraethylene glycol, propylene glycol, dipropylene glycol, tripropylene glycol, tetrapropylene glycol, 1,4-butane diol, other polyalkylene glycols having a molecular weight up to about 1000, and the like; glycol monoethers such as 2-methoxyethanol, 2-ethoxyethanol and the like; glycerin, trimethylolpropane, and the like. Two or more cosolvents can be present.

The mixture of water and cosolvent may contain from 25 to 75% by weight water, preferably 33 to 67% by weight water, more preferably from 40 to 60% by weight water, based on the combined weight of water and cosolvent.

Step a) can be performed at any temperature at which the water/cosolvent mixture is a liquid. A convenient temperature is 0 to 100° C. and a more preferred temperature is 10 to 80° C. or 20 to 60° C. In some embodiments, the precursor materials are dissolved in water at a temperature of 10 to 50° C., especially 20 to 40° C., and the cosolvent is added to the resulting solution.

It is generally convenient to add the transition metal precursor(s), dopant metal precursor(s) (if any) and HₓPO₄ precursor(s) to water and/or the water/cosolvent mixture before adding the lithium precursor. If the materials are added to water, the cosolvent preferably is added before adding the lithium precursor. A precipitate will generally form upon addition of all the precursor materials, producing a slurry.

In a particularly suitable method, the transition metal precursor(s) and dopant metal precursor(s) (if any) are added to a solution of phosphoric acid in water or water/cosolvent mixture. The transition metal precursors in this method preferably are sulfate salts of the respective transition metals. Cosolvent is then added if needed. Lithium hydroxide is then added. If less than three moles of lithium hydroxide are added per mole of HₓPO₄ ions, then an additional amount of a base as described above preferably is added to bring the pH into the ranges described above.

In step b), the mixture formed in step a) is exposed to microwave radiation in a closed container. The microwave radiation heats the mixture to a temperature of at least 150° C., up to as high as 250° C. but preferably from 160 to 225° C. The increase in temperature increases the vapor pressure within the closed container, thereby increasing the internal pressure within the container. The resulting superatmospheric pressure is high enough to prevent the water and/or cosolvent from boiling. The internal reactor pressure may increase to, for example, 1.5 to 50 bar (150 to 5000 kPa), preferably 5 to 40 bar (500 to 4000 kPa) and more preferably 15 to 35 bar (1500 to 3500 kPa). Under the conditions of elevated temperature and pressure that result from exposing the mixture to microwave radiation, the precursor materials become converted to olivine lithium transition metal phosphate particles.

The microwave radiation may have a frequency of 30 to 3000 MHz. A preferred frequency is 500 to 3000 MHz. Standard microwave ovens, which operate at a frequency of about 2450 MHz, are suitable.

The microwave heating can be continued for 1 minute to several hours. A more typical time is 5 to 30 minutes, more preferably 10 to 25 minutes.

An olivine lithium transition metal phosphate in the form of fine particles is produced in the microwave heating step. In some embodiments, the olivine lithium transition metal phosphate is a lithium manganese iron phosphate (LMFP), optionally doped with dopant metal ions. The LMFP material in some embodiments has the empirical formula LiₐMn_{b}Fe_{c}D_{d}PO₄, wherein D is the dopant metal;

a is a number from 0.5 to 1.5, preferably 0.8 to 1.2, more preferably 0.9 to 1.1 and still more preferably 0.96 to 1.1;

b is from 0.1 to 0.9, preferably from 0.65 to 0.85;

c is from 0.1 to 0.9, preferably from 0.15 to 0.35;

d is from 0.00 to 0.03, in some embodiments 0.01 to 0.03;

b+c+d=0.75 to 1.25, preferably 0.9 to 1.1, more preferably 0.95 to 1.05 and still more preferably 0.95 to 1.02; and

a+2(b+c+d) is 2.75 to 3.15, preferably 2.85 to 3.10 and more preferably 2.95 to 3.15.

A surprising and beneficial effect of this invention is that the value of a in the foregoing empirical formula is often very close to 1 when measured using inductively coupled plasma-mass spectroscopy methods, even when only an approximately stoichiometric amount of lithium is provided in the reaction mixture. When water or the cosolvent are used alone, as in US 2009-0117020, the olivine transition metal phosphate tends to be significantly deficient in lithium, unless a large excess of lithium is used. A reduction in lattice constants has also been detected when the olivine materials is prepared in a water/cosolvent mixture rather than in water alone.

The olivine transition metal phosphate particles may have a d50 particle size of, for example, from 50 nm to 5000 nm, preferably 50 to 500 nm as measured by a light scattering particle size analyzer. The presence of the cosolvent in the reaction mixture tends to lead to smaller particles being formed than when water alone is the solvent. The olivine transition metal phosphate particles in some embodiments exhibit a particle size distribution (as expressed by the ratio (d90−d10)/d50)) of 0.75 to 2.5, preferably 0.9 to 2.25 and more preferably 0.95 to 1.75. In general, the presence of near-stoichiometric amounts of lithium in the reaction solution formed in step a) tends to lead to greater agglomeration of the primary olivine transition metal phosphate particles, whereas the presence of higher amounts of lithium tends to produce particles have very little agglomeration.

After the microwave step, the olivine lithium manganese iron phosphate particles can be separated from the cosolvent using any convenient liquid-solid separation method such as filtration, centrifugation, and the like. The separated solids may be dried to remove residual water and cosolvent. This drying can be performed at elevated temperature (such as from 50 to 250° C.) and is preferably performed under subatmospheric pressure. The solids may be washed one or more times if desired with the cosolvent, water, a water/cosolvent mixture or other solvent for the cosolvent, prior to the drying step.

The olivine lithium transition metal produced in the process is useful as an electrode material, particularly as a cathode material, in various types of lithium batteries. It can be formulated into electrodes in any convenient manner, typically by blending it with a binder, forming a slurry and casting it onto a current collector. The electrode may contain particles and/or fibers of an electroconductive material such as graphite, carbon black, carbon fibers, carbon nanotubes, metals and the like. The olivine LMFP particles may be formed into a nanocomposite with graphite, carbon black and/or other conductive carbon using, for example, ball milling processes as described in WO 2009/127901, or by combining the particles with an organic compound such as sucrose or glucose and calcining the mixture at a temperature sufficient to pyrolyze the organic compound. If desired, the organic compound can be included in the reaction mixture formed in step a) of this process. Such a nanocomposite preferably contains 70 to 99% by weight of the olivine LMFP particles, more preferably 75 to 98% by weight thereof, and up to 1 to 30%, more preferably 2 to 25% by weight of carbon.

The olivine lithium transition metal phosphate produced in the process of this invention often exhibits a surprisingly high specific capacity over a range of discharge rates. This is especially the case for LMFP electrode materials made in accordance with the process. Specific capacity is measured using half-cells at 25° C. on electrochemical testing using a Maccor 4000 electrochemical tester or equivalent electrochemical tester, using in order discharge rates of C/10, 1C, 5C, 10C and finally C/10. Especially high specific capacities are seen when more than a stoichiometric amount of lithium, preferably 2.5 to 3.25 moles of lithium per mole of HₓPO₄ ions, are provided to the reaction mixture.

A lithium battery containing such a cathode can have any suitable design. Such a battery typically comprises, in addition to the cathode, an anode, a separator disposed between the anode and cathode, and an electrolyte solution in contact with the anode and cathode. The electrolyte solution includes a solvent and a lithium salt.

Suitable anode materials include, for example, carbonaceous materials such as natural or artificial graphite, carbonized pitch, carbon fibers, graphitized mesophase microspheres, furnace black, acetylene black, and various other graphitized materials. Suitable carbonaceous anodes and methods for constructing same are described, for example, in U.S. Pat. No. 7,169,511. Other suitable anode materials include lithium metal, lithium alloys, other lithium compounds such as lithium titanate and metal oxides such as TiO₂, SnO₂ and SiO₂.

The separator is conveniently a non-conductive material. It should not be reactive with or soluble in the electrolyte solution or any of the components of the electrolyte solution under operating conditions. Polymeric separators are generally suitable. Examples of suitable polymers for forming the separator include polyethylene, polypropylene, polybutene-1, poly-3-methylpentene, ethylene-propylene copolymers, polytetrafluoroethylene, polystyrene, polymethylmethacrylate, polydimethylsiloxane, polyethersulfones and the like.

The battery electrolyte solution has a lithium salt concentration of at least 0.1 moles/liter (0.1 M), preferably at least 0.5 moles/liter (0.5 M), more preferably at least 0.75 moles/liter (0.75 M), preferably up to 3 moles/liter (3.0 M), and more preferably up to 1.5 moles/liter (1.5 M). The lithium salt may be any that is suitable for battery use, including lithium salts such as LiAsF₆, LiPF₆, LiPF₄(C₂O₄), LiPF₂(C₂O₄)₂, LiBF₄, LiB(C₂O₄)₂, LiBF₂(C₂O₄), LiClO₄, LiBrO₄, LiIO₄, LiB(C₆H₅)₄, LiCH₃SO₃, LiN(SO₂C₂F₅)₂, and LiCF₃SO₃. The solvent in the battery electrolyte solution may be or include, for example, a cyclic alkylene carbonate like ethyl carbonate; a dialkyl carbonate such as diethyl cabonate, dimethyl carbonate or methylethyl carbonate, various alkyl ethers; various cyclic esters; various mononitriles; dinitriles such as glutaronitrile; symmetric or asymmetric sulfones, as well as derivatives thereof; various sulfolanes, various organic esters and ether esters having up to 12 carbon atom, and the like.

The battery is preferably a secondary (rechargeable) battery, more preferably a secondary lithium battery. In such a battery, the discharge reaction includes a dissolution or delithiation of lithium ions from the anode into the electrolyte solution and concurrent incorporation of lithium ions into the cathode. The charging reaction, conversely, includes an incorporation of lithium ions into the anode from the electrolyte solution. Upon charging, lithium ions are reduced on the anode side. At the same time, lithium ions in the cathode material dissolve into the electrolyte solution.

The battery containing a cathode which includes olivine LMFP particles made in accordance with the invention can be used in industrial applications such as electric vehicles, hybrid electric vehicles, plug-in hybrid electric vehicles, aerospace vehicles and equipment, e-bikes, etc. The battery of the invention is also useful for operating a large number of electrical and electronic devices, such as computers, cameras, video cameras, cell phones, PDAs, MP3 and other music players, tools, televisions, toys, video game players, household appliances, medical devices such as pacemakers and defibrillators, among many others.

The following examples are provided to illustrate the invention, but are not intended to limit the scope thereof. All parts and percentages are by weight unless otherwise indicated.

### EXAMPLES 1-3 AND COMPARATIVE SAMPLES A, B AND C

### Example 1

0.009 moles of manganese sulfate monohydrate and 0.003 moles of iron sulfate heptahydrate are dissolved in a mixture of 0.012 moles of phosphoric acid in 30 mL of deionized and deoxygenated water. After the salts are dissolved, 30 mL (about 25 grams) of diethylene glycol are added with stirring at about 25° C. 0.012 moles of lithium hydroxide and 0.018 moles of ammonium hydroxide are added with continued stirring. A precipitate begins to form upon addition of the lithium hydroxide. The container is closed, and the mixture is then exposed to 2450 MHz microwave radiation for five minutes, during which time the internal temperature reaches 210° C. and the internal pressure reaches about 30 bar (3000 kPa). The mixture is then cooled to room temperature. The supernatant liquid is decanted from the precipitated particles, which are then washed repeatedly with deionized water and dried overnight at 80° C. A portion of the resulting olivine LMFP particles is taken for X-ray diffraction and inductive coupled plasma analysis. Another portion of the particles is milled with 18 weight-% Ketjen Black conductive carbon and dried at 200° C. for 12 hours under nitrogen to produce particles of electrode material.

An electrode is made by mixing 93 parts by weight of the carbon-coated LMFP particles, 2 parts carbon fibers and 5 parts of polyvinylidene fluoride (as a solution in N-methyl pyrrolidone), and forming the mixture into an electrode. The electrodes are assembled into a full cell using CR2032 coin coupling with a flake graphite anode. The electrolyte is 1 M LiPF₆ in a 1:1 by volume mixture of ethylene carbonate and diethyl carbonate. The separator is a Celgard C480 type. The cells are charged at constant current to 4.25V @1C, and discharged at constant voltage to C/100. The cells are then cycled through charge/discharge cycles at 0.1 C, 1 C, 2 C, 5 C, 10 C to 2.7V. Specific capacities are as described in Table 1.

Example 2 is made and tested in the same way as Example 1, except the amount of lithium hydroxide is increased to 0.024 moles.

Example 3 is made and tested in the same way as Example 1, except the amount of lithium hydroxide is increased to 0.036 moles and the ammonium hydroxide is omitted.

Comparative Samples A-C are made in the same manner as Examples 1-3, respectively, except in each case the amount of water is doubled and the diethylene glycol is omitted.

In each case, X-ray diffraction studies are consistent with an olivine lithium manganese iron phosphate structure. Lattice parameters are as indicated in Table 1.

TABLE 1

| Sample | Li:HₓPO₄ | | Lattice Parameters | | | |
|---|---|---|---|---|---|---|
| Designation | ratio | Solvent | a (Å) | b (Å) | c (Å) | V (Å)³ |
| 1 | 1:1 | Water/ | 10.423 | 6.069 | 4.7365 | 299.618 |
| | | DEG | | | | |
| A* | 1:1 | Water | 10.46 | 6.0769 | 4.7543 | 302.204 |
| 2 | 2:1 | Water/ | 10.438 | 6.0784 | 4.7458 | 301.103 |
| | | DEG | | | | |
| B* | 2:1 | Water | 10.461 | 6.0763 | 4.7523 | 302.076 |
| 3 | 3:1 | Water/ | 10.416 | 6.0683 | 4.7360 | 300.330 |
| | | DEG | | | | |
| C* | 3:1 | Water | 10.437 | 6.0738 | 4.7444 | 300.758 |

Results from inductive coupled plasma analysis of Examples 1 and 3 and

Comparative Samples A and C are as indicated in Table 2.

TABLE 2

| | | | ICP Analysis (Mole Ratios | | |
|---|---|---|---|---|---|
| Sample | Li:HₓPO₄ | | of Stated Elements) | | |
| Designation | ratio | Solvent | Li/P | Mn/Fe | M/P¹ |
| 1 | 1:1 | Water/DEG | 0.85 | 2.9 | 1.05 |
| A* | 1:1 | Water | 0.77 | 2.92 | 1.15 |
| 3 | 3:1 | Water/DEG | 0.93 | 3.1 | 1.03 |
| C* | 3:1 | Water | 0.85 | 3.05 | 1.08 |

*Not an example of the invention.
¹M designates transition metals (iron and manganese).

As can be seen from the data in Table 2, higher lithium contents (for a given starting ratio of lithium to phosphorus) are obtained when a cosolvent mixture is used instead of simply water.

Results from battery cell testing are as indicated in Table 3.

TABLE 3

| Sample | Li:HₓPO₄ | | Specific Capacity, mAh/g | | | |
|---|---|---|---|---|---|---|
| Designation | ratio | Solvent | C/10 | 1 C | 5 C | 10 C |
| 1 | 1:1 | Water/DEG | 101 | 82 | 45 | 19 |
| A* | 1:1 | Water | 34 | 23 | 10 | 4 |
| 2 | 2:1 | Water/DEG | 124 | 112 | 80 | 44 |
| B* | 2:1 | Water | 38 | 27 | 15 | 10 |
| 3 | 3:1 | Water/DEG | 144 | 140 | 83 | 41 |
| C* | 3:1 | Water | 100 | 86 | 56 | 28 |

Examples 1 through 3 all exhibit much greater capacities as all discharge rates than Comparative Samples A-C, respectively.

### EXAMPLES 4 AND 5 AND COMPARATIVE SAMPLE D

### Example 4

0.009 moles of manganese sulfate monohydrate and 0.003 moles of iron sulfate heptahydrate are dissolved in a mixture of 0.012 moles of phosphoric acid in 60 mL of deionized and deoxygenated water. After the salts are dissolved, 30 mL (about 25 grams) of diethylene glycol are added with stirring at about 25° C. 0.036 moles of lithium hydroxide are added with continued stirring. A precipitate begins to form upon addition of the lithium hydroxide. The container is closed, and the mixture is then exposed to 2450 MHz microwave radiation for five minutes, during which time the internal temperature reaches 210° C. and the internal pressure reaches about 30 atmospheres (3000 kPa). The mixture is then cooled to room temperature. The supernatant liquid is decanted from the precipitated particles, which are then washed repeatedly with deionized water and dried overnight at 80° C. A portion of the resulting olivine LMFP particles is taken for X-ray diffraction, for inductive coupled plasma analysis, for particle size analysis (in a Beckman Coulter particle size analyzer), BET surface area and tap density. Another portion of the particles is ultrasonicated, mixed with a solution of glucose and sucrose in water for 30 minutes, spray dried and calcined under nitrogen at 700° C. for one hour to produce carbon-coated particles containing about 3% by weight carbon. A portion of the carbon-coated material is made into electrodes and tested as described in the previous examples.

Example 5 is made and tested the same way, except that the diethylene glycol is replaced with an equal volume of isopropanol.

Comparative Sample D is made and tested in the same manner as Examples 4 and 5, except the cosolvent is omitted and the amount of water is doubled to 60 mL.

In each case, X-ray diffraction studies are consistent with an olivine lithium manganese iron phosphate structure. Lattice parameters are as indicated in Table 4.

TABLE 4

| Sample | | Lattice Parameters | | | |
|---|---|---|---|---|---|
| Designation | Solvent | a (Å) | b (Å) | c (Å) | V (Å)³ |
| D* | Water | 10.446 | 6.077 | 4.741 | 300.94 |
| 4 | Water/DEG | 10.417 | 6.066 | 4.737 | 299.26 |
| 5 | Water/IPA | 10.421 | 6.072 | 4.734 | 300.60 |

Results from inductive coupled plasma analysis of Examples 4 and 5 and Comparative Sample D are as indicated in Table 5.

TABLE 5

| | | ICP Analysis (Mole Ratios | | |
|---|---|---|---|---|
| Sample | | of Stated Elements) | | |
| Designation | Solvent | Li/P | Fe/P | Mn/P |
| D* | Water | 0.936 | 0.271 | 0.821 |
| 4 | Water/DEG | 1.01 | 0.262 | 0.788 |
| 5 | Water/IPA | 1.005 | 0.265 | 0.787 |

*Not an example of the invention.
¹M designates transition metals (iron and manganese).

As before, higher lithium contents (for a given starting ratio of lithium to phosphorus) are obtained when the cosolvent mixture is used instead of simply water.

Particle size and surface area for Examples 4 and 5 and Comparative Sample D are as given in Table 6.

TABLE 6

| | | | | Surface | Tap |
|---|---|---|---|---|---|
| Sample | Mean Particle | D50, | D90, | area, | Density, |
| Designation | Size, μm | μm | μm | m²/g | g/cc |
| D* | 0.256 | 0.264 | 0.446 | 6.3 | 0.67 |
| 4 | 0.126 | 0.116 | 0.194 | 25.8 | 0.99 |
| 5 | 0.206 | 0.134 | 0.340 | 11.8 | 1.08 |

The data in Table 6 illustrates significant morphological differences between the sample prepared in water and those prepared in water/cosolvent mixtures. Comparative Sample D has a larger particle size and a wider particle size distribution. Comparative Sample D exhibits a bimodal particle distribution. The larger particle size of Comparative Sample D leads to a low surface area and a low tap density. The low tap density of Comparative Sample is a significant disadvantage, as the inability to pack the particles close together leads to lower energy densities when the material is formed into an electrode.

By contrast, Examples 4 and 5 have much smaller particle sizes, much higher surface areas and much higher tap densities. Example 4 has a very uniform particle size, whereas Example 5 consists mainly of fine primary particles with a small shoulder of larger agglomerates. The morphological differences between Comparative Sample D and Examples 4 and 5 correlate to better battery performance, as indicated in Table 7.

TABLE 7

| | |
|---|---|
| Sample | Specific Capacity, mAh/g |

| Designation | Solvent | C/10 | 1 C | 5 C | 10 C |
|---|---|---|---|---|---|
| D* | Water | 3 | 36 | 26 | 17 |
| 4 | Water/DEG | 140 | 128 | 114 | 100 |
| 5 | Water/IPA | 136 | 123 | 107 | 93 |

### EXAMPLE 6 AND COMPARATIVE SAMPLE E

To produce Example 6 and Comparative Sample E, Example 4 and Comparative Sample D are repeated, in each case adding 3 grams of glucose to the reaction mixture prior to microwave treatment. The recovered LMFP particles are washed and dried as before, and then calcined at 700° C. under nitrogen for one hour to produce a carbon-coated electrode material.

Example 6, prepared with a water/diethylene glycol solvent mixture, has a surface area of about 54 m²/g, compared to only 38 m²/g for Comparative Sample E, made using water as the only solvent. A full-cell made using the Example 6 material shows a specific capacity of 130 mAh/g at a C/10 discharge rate, 120 mAh/g at a 1C discharge rate and 107 mAh/g at a 5C discharge rate, compared to 32 mAh/g at a C/10 discharge rate, 26 mAh/g at a 1C discharge rate and 10 mAh/g at a 5C discharge rate for Comparative Sample E.

1. A microwave-assisted, solvothermal method for making olivine lithium transition metal phosphate particles, comprising the steps of:
a) combining precursor materials including at least one source of lithium ions, at least one source of transition metal ions, and at least one source of HₓPO₄ ions where x is 0-2 in a solvent mixture of 20 to 80% by weight water and 80 to 20% by weight of at least one liquid alcoholic cosolvent which is miscible with water at the relative proportions of water and cosolvent that are present, to form a mixture,
b) exposing the mixture formed in step a) to microwave radiation in a closed container to heat the mixture to a temperature of at least 150° C., form superatmospheric pressure in the closed container and convert the precursor materials to an olivine lithium transition metal phosphate and
c) separating the olivine lithium transition metal phosphate particles from the solvent mixture.

2. The method of claim 1, wherein the alcoholic cosolvent is one or more of methanol, ethanol, isopropanol, n-propanol, n-butanol, t-butanol, sec-butanol, n-pentanol, n-hexanol, ethylene glycol, diethylene glycol, triethylene glycol, tetraethylene glycol, propylene glycol, dipropylene glycol, tripropylene glycol, tetrapropylene glycol, 1,4-butane diol, a polyalkylene glycol having a molecular weight up to 1000; 2-methoxyethanol, 2-ethoxyethanol, glycerin or trimethylolpropane.

3. The method of claim 2, wherein the alcoholic cosolvent is diethylene glycol.

4. The method of claim 1, wherein the solvent mixture contains 40 to 60% by weight water and 60 to 40% by weight of the alcoholic cosolvent.

5. The method of claim 1, wherein the transition metal is iron or a mixture of iron and manganese.

6. The method of claim 5, wherein the transition metal is a mixture of iron and manganese at a mole ratio of 10:90 to 35:65.

7. The method of claim 1, wherein the precursor materials include at least one dopant metal precursor, and the dopant metal precursor is present in an amount of 1 to 3 mole-percent based on total moles of transition metal precursor(s) and dopant metal precursor.

8. The method of claim 1, wherein the microwave radiation has a frequency of 500 to 3000 MHz, and the mixture is exposed to the microwave radiation for 5 to 30 minutes.

9. The method of claim 1, wherein the superatmospheric pressure is 150 to 4000 kPa.

10. The method of claim 1, wherein the temperature in step b) is 160 to 225° C.

11. The method of claim 1, wherein step a) is performed by adding the transition metal precursor(s) to a solution of phosphoric acid in water or a mixture of water and the alcoholic cosolvent, adding cosolvent if necessary, then adding lithium hydroxide.

12. The method of claim 1 wherein the olivine lithium transition metal particles are lithium manganese iron phosphate particles having the empirical formula LiₐMn_{b}Fe_{c}D_{d}PO₄, wherein D is the dopant metal; a is 0.5 to 1.5; b is from 0.1 to 0.9; c is from 0.1 to 0.9; d is from 0.00 to 0.03; b+c+d=0.75 to 1.25; and a+2(b+c+d) is 2.75 to 3.15.

13. The method of claim 1 wherein the olivine lithium transition metal particles are lithium manganese iron phosphate particles having the empirical formula LiₐMn_{b}Fe_{c}D_{d}PO₄, wherein D is the dopant metal; a is 0.9 to 1.1; b is from 0.65 to 0.85; c is from 0.15 to 0.35; d is from 0.00 to 0.03; b+c+d=0.95 to 1.05; and a+2(b+c+d) is 2.85 to 3.15.

14. The method of claim 1 wherein the olivine lithium transition metal particles are lithium manganese iron phosphate particles having the empirical formula LiₐMn_{b}Fe_{c}D_{d}PO₄, wherein D is the dopant metal; a is 0.96 to 1.1; b is from 0.65 to 0.85; c is from 0.15 to 0.35; d is from 0.01 to 0.03; b+c+d=0.95 to 1.02; and a+2(b+c+d) is 2.95 to 3.15.
